(19) United States
(12) Patent Application Publication
(10) Pub. No.: US 2010/0153731 A1
(43) Pub. Date: Jun. 17, 2010

(54) Lightweight Authentication Method, System, and Key Exchange Protocol For Low-Cost Electronic Devices

(75) Inventors: Dang Nguyen Duc, Yuseong-gu (KR); Hyunrok Lee, Yuseong-gu (KR); Kwangjo Kim, Yuseong-gu (KR)

Correspondence Address: CROWELL & MORING LLP;INTELLECTUAL PROPERTY GROUP, P.O. BOX 14300, WASHINGTON, DC, 20044-4300, US

(73) Assignee: INFORMATION AND COMMUNICATIONS UNIVERSITY, Yuseong-gu (KR)

(21) Appl. No.: 12/337,535

(22) Filed: Dec. 17, 2008

(51) Int. Cl. H04L 9/32; H04L 9/08; G06N 5/02

(52) U.S. Cl. 713/175; 380/283; 706/46; 380/270

(57) ABSTRACT

An algorithm or an authentication system for a low-cost authenticating device such as a radio frequency identification (RFID) tag, or a sensor node are provided, by which authentication is processed efficiently without requiring complicated hardware. A claimant entity attempting to be authenticated and a verifying entity to authenticate the claimant entity, share a plurality of secret keys so that authentication is processed as the claimant entity responds to a challenge by the verifying entity. The verifying entity and the claimant entity perform authentication using Learning Parity with Noise (LPN) problem. The verifying entity and the claimant entity generate keys independently from one another, and exchange the generated keys. The claimant entity may generate an encrypted value for use in the authentication, using a basic Boolean Exclusive OR and a logical AND operations.

### BACKGROUND OF THE INVENTION

1. Field of the Invention

Aspects of the present invention relate to an authentication method, protocol and system for verifying authenticity of an entity such as a radio frequency identification (RFID) tag, a sensor node, or the like.

2. Description of the Related Art

Entity authentication involves sending an identity or characteristic information by one entity using wired or wireless communication network, and executing a protocol to authenticate the received information by a responding entity. The authentication mainly uses symmetric key or public key.

Symmetric key-based authentication is a protocol by which entities participating in authentication exchange share a secret key on a one-to-one basis. This symmetric key authentication can guarantee high security, and entities involved in the authentication exchange can have symmetricity. However, the symmetric key authentication suffers from several shortcomings. That is, a large storage space is required to store secret keys, since symmetric key authentication requires that separate secret keys be generated and managed for each of the counterpart entities. Besides, a complicated hardware is required to manage the secret keys.

Public key-based authentication can be used between a verifying entity (verifier) to authenticate a counterpart and a claimant entity (claimant) attempting to be authenticated, in which the entities involved in the authentication exchange share a public key provided by a public organization. The public key-based authentication may be executed asymmetrically. For example, if a device such as a RFID reader is the verifier and RFID tags are the claimants, the verifier and the claimants A and B can share a public key, while the claimant A and verifier share a secret key A to execute authentication. The claimant B and the verifier can share a secret key B to perform authentication.

While the verifier stores therein and manages all the keys required for authentication, including the secret keys A and B and the public key for the authentication with the claimants A and B, the claimant A stores the public key and secret key A, and the claimant B stores the public key and secret key B.

The symmetric key authentication and public key authentication protocols need complicated authentication processes at the claimants to ensure high security. To perform complicated authentication processes, the hardware of the claimants has increased complexity and thus becomes more expensive. This makes the above authentication protocols unsuitable for use on a low-cost device such as RFID tag.

Accordingly, there is a need for an authentication protocol for use with a RFID tag, which is capable of executing efficient authentication without requiring a complicated hardware.

### SUMMARY OF THE INVENTION

Aspects of the present invention provide an authentication system in which a verifying entity to authenticate its counterpart and a claimant entity attempting to be authenticated, independently generate and send keys to one another and thus are secure against man-in-the-middle attack.

Aspects of the present invention also provide an authentication system and method which do not require additional primitive. The authentication system and method allow flexibility in choosing security parameter. Accordingly, with the optimized choice, the authentication system can have further increased security. The authentication system and method can be used as a key exchange protocol without requiring additional steps.

Aspects of the present invention also provide an authentication system and method which do not suffer from incompleteness problem.

In accordance with an example embodiment of the present invention, there is provided an authentication system including a verifying entity to authenticate a counterpart and a claimant entity attempting to be authenticated, in which the claimant entity sends a first calculated value to the verifying entity, the verifying entity sends a second calculated value to the claimant entity, the claimant entity sends a response value to the verifying entity in response, and the verifying entity authenticates the response value using the first calculated value.

In accordance with another example embodiment of the present invention, there is provided an authentication method according to which a verifying entity to authenticate a counterpart and a claimant entity attempting to be authenticated, share a plurality of secret keys and the claimant entity performs authentication by communicating with the verifying entity. The authentication method may include: generating a first calculated value using a first key and a first secret value, sending the first key and the first calculated value to the verifying entity, receiving from the verifying entity a second key and a second calculated value, the second calculated value being generated using the second key and a second secret value, predicting the second secret value that corresponds to the second calculated value, using the second key and the second calculated value, generating a response value based on the predicted second calculated value, and sending the response value to the verifying entity.

In accordance with another example embodiment of the present invention, there is provided an authentication method according to which a verifying entity to authenticate a counterpart and a claimant entity attempting to be authenticated, share a plurality of secret keys and the verifying entity authenticates the claimant entity. The authentication method may include receiving from the claimant entity a first key and a first calculated value, the first calculated value being generated using the first key and a first secret value, generating a second calculated value using a second key and a second secret value, sending the second key and the second calculated value to the claimant entity, receiving a response value from the claimant entity, predicting the first secret value using the first key and the first calculated value, and verifying the response value based on the predicted first secret value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a process of executing q rounds of authenticating steps between a radio frequency identification (RFID) tag and a RFID reader according to an exemplary embodiment of the present invention;

FIG. 2 illustrates in detail one authentication step execute between a RFID tag and a RFID reader according to an exemplary embodiment of the present invention;

FIG. 3 is a flowchart illustrating in detail a process of authentication executed at the RFID tag of FIG. 2 according to an exemplary embodiment of the present invention; and

FIG. 4 is a flowchart illustrating in detail a process of authentication executed at the RFID reader of FIG. 2 according to an exemplary embodiment of the present invention.

### DETAILED DESCRIPTION OF THE EMBODIMENTS

Reference will now be made in detail to the example embodiments of the present invention, examples of which are illustrated in the accompanying drawings, wherein like reference numerals refer to like elements throughout. The embodiments are described below in order to explain the aspects of the present invention by referring to the figures.

HB authentication protocol proposed by Hopper and Blum brought new approach to designing lightweight cryptographic protocols. HB authentication protocol is based on a new foundation called Learning Parity with Noise (LPN) problem. The core operation in the LPN problem is binary inner-product which requires just a linear number of XOR and AND operations.

LPN problem has been extensively studied and known to be nondeterministic polynomial-complete (NP-complete).

It is known to take 2^{O(n/log n)} even for the fastest algorithm to solve the LPN problem.

Unfortunately, HB protocol is designed for human-to-computer authentication, and cannot be used for device-to-device authentication. An improved protocol called HB+proposed by Juels and Weis made it possible to use this kind of protocol for device-to-device authentication.

However, HB+ protocol is not satisfactorily secure against a stronger attack called ‘man-in-the-middle attack’. The ‘man-in-the-middle attack’ is a type of attack that intercepts secret information sent and received between a verifying entity (‘verifier’) such as a RFID reader and a claimant entity (‘claimant’) such as a RFID tag, and relays tampered information.

Furthermore, both HB and HB+ suffer from a problem called incompleteness. That is, even though genuine claimant and verifier follow protocols correctly, there is still a chance that authentication may fail.

The authentication system and method according to an exemplary embodiment of the present invention use a cryptography based on HB protocol, is secure against man-in-the-middle attack, and does not suffer from incompleteness problem.

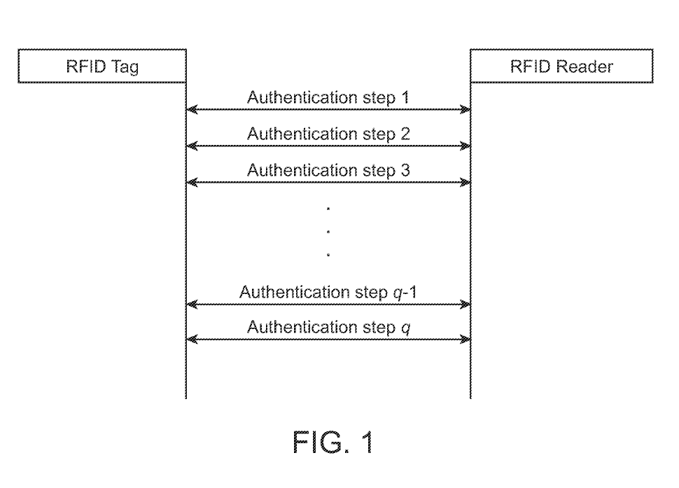

FIG. 1 illustrates q rounds of authentication steps executed between a RFID reader as a verifier and a RFID tag as a claimant.

Efforts have constantly been made to make it easier to identify persons or products especially in the field of commerce. The identity cards or passwords can be the typical examples of the ways to verify the identity of a person, and these traditional methods have appropriately been adapted for use on electronic devices.

However, passwords are easily exposed or stolen. For example, a malicious attacker may steal a credit card password and withdraw deposit from a credit card owner's account.

The magnetic card or radio frequency identification (RFID) is the technology introduced to prevent one's identity or password from being exposed to such a potential identity thief. The RFID enables recognition of information in from several centimeters to several meters of distance depending on the design.

The speed of recognition is approximately 0.01˜0.1 seconds, which is faster and less subjective to an external influence than the other types of media such as magnetic.

The RFID technology chip also can store relatively a large amount of information.

The RFID technology is achieved by data transmission and reception between a RFID reader and a RFID tag. The RFID tag may include an integrated circuit (IC) to store information, and an antenna. The capacity of the RFID tag to store information depends on the size of memory embedded in the IC chip.

The RFID reader may provide energy to operate the RFID tag. The RFID reader may send a command, requesting the RFID tag to perform a specific operation. Accordingly, in response to the command from the RFID reader, the RFID tag may send data to the RFID reader.

The RFID reader and RFID tag may communicate in an inductively coupled manner, or by using electromagnetic waves. The inductively coupled scheme is generally used for short distance communication which is generally within 1 meter, while the electromagnetic wave-based scheme is generally used for middle, or long distance communication exceeding 1 meter.

The energy to operate the RFID tag may be provided by the RFID reader. Alternatively, the RFID tag may be connected to an energy source such as a battery.

According to an exemplary embodiment of the present invention, a verifier, including RFID reader, may request a claimant, including RFID tag, a response. If the claimant sends a response message to the verifier in response, the verifier determines whether or not the response message meets a predetermined rule. If the received response message meets the predetermined rule, the verifier determines the claimant to be a genuine entity and thus gives an access to the information stored in the verifier.

However, if the response message from the claimant does not meet the predetermined rule, the verifier determines authentication to have failed, and refuses the access of the claimant to the verifier.

According to an exemplary embodiment of the present invention, if the authentication is successful, the verifier may additionally read data stored in the claimant, and update the data previously stored in the verifier based on the read data. In this case, the verifier may send a data request command to the claimant, and the claimant may send the requested data to the verifier in response.

According to an exemplary embodiment of the present invention, the verifier may include, or be connected to a database to store information about the registered claimants.

According to an exemplary embodiment of the present invention, the verifier may control a mobile device. Accordingly, if authentication is successful, the verifier may allow the claimant to use the mobile device.

The operation of the verifier requesting a response from the claimant, and determining authentication to be a success or failure based on the received response message, may form one authentication step.

The authentication steps may be executed independently, and authentication is considered to be successful if all q rounds of authentication steps are successful. The q steps may be executed in parallel or sequentially.

The verifier and the claimant may generate session bits in each of the authentication steps, and thus generate q-bit session keys throughout the q steps.

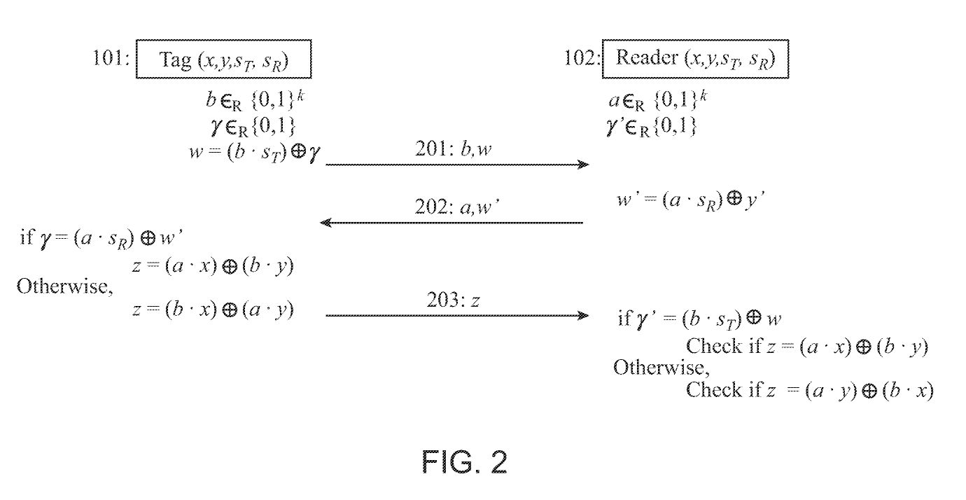

FIG. 2 illustrates in detail each of the authentication step of FIG. 1 according to an exemplary embodiment of the present invention.

A tag 101 and a reader 102 share four shared secret keys (x, y, S_{T}, S_{R}). The tag 101 may store the four shared secret keys in its internal memory.

The tag 101 generates a k-bit first key b randomly.

Each of the first key b may have one of the values {0, 1}.

The tag 101 may choose a 1-bit first secret value r randomly.

The tag 101 may compute a binary inner-product, that is, (b·S_{T}) of the first key b and the first shared secret key S_{T}. The tag 101 generates a first calculated value w by computing logical XOR operation of (b·S_{T}) and the first secret value r.

The first calculated value w may be expressed by:

w=(b·S_{T})⊕r [Mathematical formula 1]

where ⊕ denotes logical XOR operation.

The binary inner-product of the k-bit bit streams may be computed as explained below.

For example, given a=(a₀a₁a₂ . . . a₍ₖ₋₁₎)₂ and, x=(x₀x₁x₂ . . . x₍ₖ₋₁₎)₂, the binary inner-product (a·x) of a and x may be computed by:

a·x=(a₀ ̂ x₀)⊕(a₁ ̂ x₁)⊕ . . . ⊕(a₍ₖ₋₁₎ ̂ x₍ₖ₋₁₎) [Mathematical formula 2]

where ̂ denotes logical AND operation.

The tag 101 sends the first key b and the first calculated value w to the reader 102.

The reader 102 generates a k-bit second key a randomly.

Each bit of the second key a may have one of the values {0, 1}.

The reader 102 may choose a 1-bit second secret value r′ randomly.

The reader 102 may compute a binary inner-product (a·S_{R}) of the second key a and the second shared secret key S_{R}. The reader 102 may generate a second calculated value w′ by computing logical XOR operation of the binary inner-product (a·S_{R}) and the second secret value r′.

The second calculated value w′ may be expressed by:

w′=(a·S_{R})⊕r′ [Mathematical formula 3]

The reader 102 sends the second key a and the second calculated value w′ to the tag 101.

The tag 101 may obtain a predicted second secret value r′, using the second key a and the second calculated value w′ as received. The predicted second secret value r′ may be expressed by:

r′=(a·S_{R})⊕w′ [Mathematical formula 4]

The tag 101 determines if the predicted second secret value r′ matches the first secret value r, and determines to choose one of a first and second encryption equations according to whether or not the predicted second secret value r′ matches the first secret value r.

That is, if the predicted second secret value r′ matches the first secret value r, the tag 101 generates a response value z using the first encryption equation.

The response value z may be expressed by:

z=(a·x)β(b·y) [Mathematical formula 5]

where x, y are shared secret keys shared by the tag 101 and the reader 102.

If the predicted second secret value r′ does not match the first secret value r, the tag 101 generates a response value z using the second encryption equation.

The response value z may be expressed by:

z=(b·x)⊕(a·y) [Mathematical formula 6]

where x, y are shared secret keys shared by the tag 101 and the reader 102.

The tag 101 sends a response value z to the reader 102.

The reader 102 predicts a first secret value r using the received first key a and first calculated value w.

The predicted first secret value r may be expressed by:

r=(b·S_{T})⊕w [Mathematical formula 7]

The reader 102 determines whether the predicted first secret value v matches the second secret value r′. Depending on whether the predicted first secret value r matches the second secret value r′ or not, the reader 102 chooses one of the first and second encryption equations.

If the first secret value r matches the second secret value r′, the reader 102 checks a response value z using the first encryption equation. However, if the predicted first secret value r does not match the second secret value r′, the reader 102 checks the response value z using the second encryption equation.

In other words, the reader 102 considers authentication to be successful if the predicted first secret value r matches the second secret value r′ and z=(a·x)⊕(b·y). The reader 102 may also considers authentication to be successful if the predicted first secret value r does not match the second secret value r′ and z=(b·x)⊕(a·y).

The tag 101 and the reader 102 may share securely the result of r ⊕ r′, which is the XOR operation of the first and second secret values r, r′.

The tag 101 and the reader 102 may share r ⊕ r′ whenever each authentication step succeeds, and if q authentication steps are successful, may use the q-bit shared values as session keys.

The tag 101 and the reader 102 may update the previously shared secret keys (x, y, S_{T}, S_{R}) using the session keys.

The tag 101 and the reader 102 may generate keys and secret values independently, and generate calculated values using the shared secret keys. The tag 101 and the reader 102 may send the key and the calculated value to the counterparts.

The authentication protocol according to the exemplary embodiments of the present invention can be called a HB* (read HB star) protocol.

The calculated value can be interpreted only by the combination with the previously shared secret key. Accordingly, even if the calculated value is exposed during data transaction between the tag 101 and the reader 102, the chance of having the secret value exposed is reduced.

The tag 101 and the reader 102 generate keys and calculated values independently and send the generated keys and values to one another. The tag 101 and the reader 102 generate or authenticate a response value using the key and calculated value, which are independently generated and received from one another, and thus can remain secure even if calculated value is intercepted by the man-in-the-middle attack. That is, the tag 101 alone involves in the generation of the first key b and the first calculated value w, while the reader 101 is not involved. Likewise, only the reader 102 involves in the generation of the second key a and the second calculated value w′.

Since the tag 101 and the reader 102 use the keys and the calculated values generated only by themselves, successful authentication is impossible by intercepting the calculated value, i.e., by the man-in-the-middle attack.

The tag 101 and the reader 102 may perform encryption based on Learning Parity with Noise (LPN) problem. Since hardware can be realized with the simple AND and XOR operations, the complexity of hardware at the tag 101 and the reader 102 can be reduced significantly.

Choosing the first or second secret value r or r′ may be drawn by the arbitrary probability distribution. The second secret value r or r′ can be chosen from the uniform probability distribution which leads to the hardest instance of LPN problem.

The tag 101 may compute a response value using one of two formulas according to the values of r and r′. Therefore, No noise needs to be applied to the response value. The response value may be generated using a shared secret key, or a key sent to or received from the reader 102.

As a result, the reader 102 can ensure successful authentication of a genuine tag 101. The tag 101 and the reader 102 may provide a perfectly complete protocol.

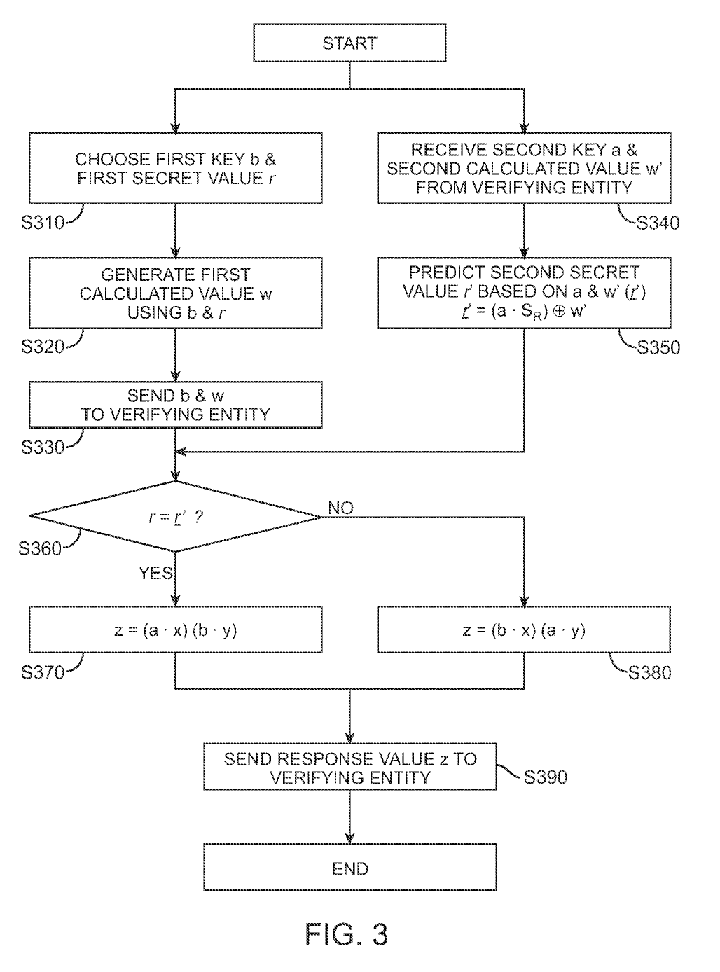

FIG. 3 is a flowchart illustrating in detail the authentication executed at the tag 101 of FIG. 2 according to an exemplary embodiment of the present invention.

The tag 101 chooses a first key b and a first secret value r at S310. In this situation, the tag 101 may choose the first key b and the first secret value r based on the random probability distribution.

The tag 101 generates a first calculated value w using the first key b and the first secret value r at S320. The first calculated value w may be generated using mathematical formula 1 explained above. The tag 101 computes binary inner-product of the first key b and the first shared secret key S_{T}, and performs logical XOR operation of the binary inner-product and the first secret value r to generate a first calculated value w.

The tag 101 sends the first key b and the first calculated value w to the reader 102 at S330. Since the data (or codeword) sent from the tag 101 to the reader 102, does not directly include the first secret value r, the first secret value r is not directly exposed even when the codeword is intercepted during transmission.

The tag 101 receives a second key a and a second calculated value w′ from the reader 102 at S340.

The tag 101 predicts a second secret value r′ based on the second key a and the second calculated value w′ at S350. The predicted second secret value r′ may be computed using mathematical formula 4 explained above. The tag 101 computes binary inner-product of the second key a and the second shared secret key S_{R}, and computes the predicted second secret value r′ based on the result of logical XOR operation of the binary inner-product and the second calculated value w′.

The operations at S310 to S330 may be performed in parallel with the operations at S340 to S350, or alternatively, these operations may be performed sequentially. The operations at S310 to 330 may also be performed independently from the operations at S340 to S350.

The tag 101 determines whether or not the first secret value r and the predicted second secret value r′ match at S360. Although FIG. 3 exemplarily depicts that S320 to S330 are performed prior to S360, according to an alternative example, S320 to S330 may be performed in parallel with S360 to S390, or sequentially.

If the first secret value r and the predicted second secret value r′ match, the tag 101 generates a response value z using the first encryption equation at S370. The response value z may be computed using mathematical formula 5 explained above.

If the first secret value r and the predicted second secret value r′ do not match, the tag 101 generates a response value z using the second encryption equation at S380. The response value z may be computed using mathematical formula 6 explained above.

The tag 101 sends the response value z, either generated at S370 or S380, to the reader 102 at S390.

The tag 101 may perform an additional step of generating a session key by computing logical XOR operation of the first secret value r and the predicted second secret value r′. Since the tag 101 generates a response value z using the first secret value r and the first key a generated at the tag 101, and the predicted second secret valuer′ generated at the reader 102 and predicted at the tag 101 and the second key b, it is necessary that the man-in-the-middle attack intercepts all the codeword transmitted from the tag 101 to the reader 102 and vice versa in order to access the authentication system of the tag 101 and the reader 102. Therefore, the authentication system between the tag 101 and the reader 102 can increase security against the man-in-the-middle attack.

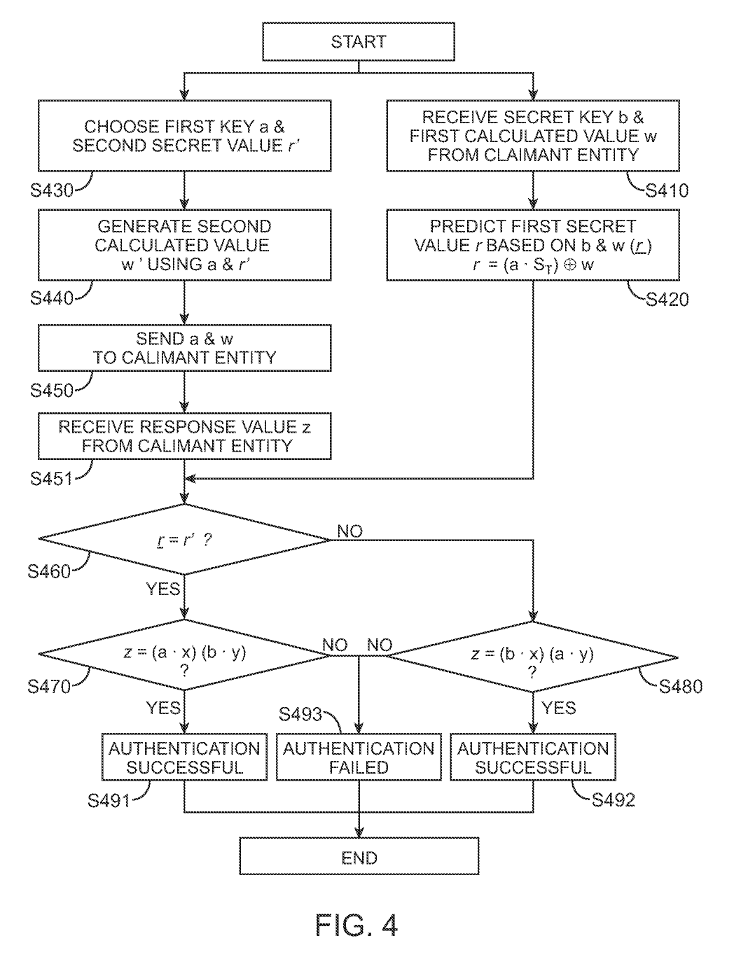

FIG. 4 is a flowchart illustrating in detail authentication executed at the reader 102 of FIG. 2 according to an exemplary embodiment of the present invention.

The reader 102 receives a first key b and a first calculated value w from the tag 101 at S410.

The reader 102 predicts the first secret value r using the first key b and the first calculated value w at S420. The predicted first secret value r may be computed by mathematical formula 7 explained above. The reader 102 computes binary inner-product of the first key b and the first shared secret key S_{T}, and computes the predicted first secret value r by performing logical XOR operation of the binary inner-product and the first calculated value w.

The reader 102 choose a second key a and a second secret value r′ at S430. The reader 102 may choose the second key a and the second secret value r′ based on the random probability distribution.

The reader 102 generates a second calculated value w′ using the second key a and the second secret value r′ at S440. The second calculated value w′ may be computed based on mathematical formula 3 explained above. The reader 102 computes binary inner-product of the second key a and the second shared secret key S_{R}, and generates a second calculated value w′ by performing logical XOR operation of the binary inner-product and the second secret value r′.

The reader 102 sends the second key a and the second calculated value w′ to the tag 101 at S450. The reader 102 receives a response value z from the tag 101 at S451. The response value z corresponds to the second key a and the second calculated value w′.

The operations at S410 to S420 may be performed independently from the operations at S430 to S451. The operations at S410 to S420 may be performed in parallel with the operations at S430 to S450, or sequentially.

The reader 102 may determine whether the predicted first secret value r and the second secret value r′ match at S460.

If the predicted first secret value r matches the second secret value r′, the reader 102 determines whether or not the response value z meets the first encryption equation S470. The first encryption equation may be expressed by mathematical formula 5.

If the response value z meets the first encryption equation, the reader 102 determines authentication to be successful at S491. If the response value z does not meet the first encryption equation, the reader 102 determines authentication to have failed at S493.

If the predicted first secret value r does not match the second secret value r′, the reader 102 determines whether or not the response value z meets the second encryption equation at S480. The second encryption equation may be expressed by mathematical formula 6.

If the response value z meets the second encryption equation, the reader 102 determines authentication to be successful at S492. If the response value z does not meet the second encryption equation, the reader 102 considers authentication to have failed at S493.

The reader 102 verifies the response value z, using not only the second key a and the second secret value r′ generated at the reader 102 and the predicted first secret value r predicted by the reader 102 and the first key b, but also the first shared secret key S_{T} and the second shared secret key S_{R} shared by the tag 101 and the reader 102. Since the codeword (b, w) of the reader 102, and the codeword (a, w′) of the tag 101 are generated by an independent process, the authentication system of the reader 102 and the tag 101 is secure against the man-in-the-middle attack.

The method according to the exemplary embodiments of the present invention may be realized as a program command which can be executed by a variety of computer means, and recorded on a computer-readable medium. The ‘computer-readable medium’ herein may refer to a program command, data file, data structure, or any combination thereof. The program command recorded on the medium may be designed and constructed specifically for application of the exemplary embodiments of the present invention, or alternatively, the program command may be that which is already known to and used by those skilled in the field of computer software. The computer readable medium may include a magnetic media such as hard disk, floppy disk or magnetic tape, an optical media such as CD-ROM or DVD, a magneto-optical media such as floptical disk, and a hardware device such as ROM, RAM or flash memory, which is constructed specifically to store and execute the program command. The program command may include not only a mechanical language code which is constructed by a compiler, but also an advanced language code which can be executed on a computer using appropriate tool such as an interpreter. The hardware device may be designed to operate as one or more software modules to execute the steps according to the exemplary embodiments of the present invention, or the opposite is also possible.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof.

Accordingly, it is intended, therefore, that the present invention not be limited to the various example embodiments disclosed, but that the present invention includes all embodiments falling within the scope of the appended claims.

What is claimed is:

1. An authentication method according to which a claimant entity attempting to be authenticated and a verifying entity to authenticate the claimant entity, share a plurality of secret keys and authentication is processed as the claimant responds to a challenge by the verifying entity, the authentication method comprising:
generating a first calculated value using a first key and a first secret value;
sending the first key and the first calculated value to the verifying entity;
receiving from the verifying entity a second key and a second calculated value, the second calculated value being generated using the second key and a second secret value;
predicting the second secret value that corresponds to the second calculated value, using the second key and the second calculated value;
generating a response value based on the predicted second calculated value; and
sending the response value to the verifying entity.

2. The authentication method of claim 1, wherein the generating of the first calculated value comprises:
choosing the first secret value randomly;
computing a binary inner-product of a first shared secret key shared with the verifying entity and the first key; and
generating the first calculated value by performing logical exclusive OR operation of the binary inner-product and the first secret value.

3. The authentication method of claim 1, wherein the predicting of the second secret value comprises:
computing binary inner-product of a second shared secret key shard with the verifying entity and the second key; and
performing logical exclusive OR operation of the binary inner-product and the second calculated value.

4. The authentication method of claim 1, wherein the generating of the response value comprises:
determining whether of not the predicted second secret value matches the first secret value;
generating the response value, using the first key, the second key and a first encryption equation, if the predicted second secret value matches the first secret value; and
generating the response value, using the first key, the second key and a second encryption equation, if the predicted second secret value does not match the first secret value.

5. The authentication method of claim 1, wherein the steps of the generating of the first calculated value, the sending of the first key and the first calculated value, the receiving of the second key and the second calculated value, the predicting of the second secret value, the generating of the response value, and the sending of the response value, are repeated a plurality of times, and authentication of the verifying entity is determined to be successful if authentication of all the repeated steps succeeds.

6. The authentication method of claim 1, further comprising generating a session secret value by performing logical exclusive OR operation of the first secret value and the predicted second secret value.

7. An authentication method according to which a claimant entity attempting to be authenticated and a verifying entity to authenticate the claimant entity, share a plurality of secret keys and authentication is processed as the claimant responds to a challenge by the verifying entity, the authentication method comprising:
receiving from the claimant entity a first key and a first calculated value, the first calculated value being generated using the first key and a first secret value;
generating a second calculated value using a second key and a second secret value;
sending the second key and the second calculated value to the claimant entity;
receiving a response value from the claimant entity;
predicting the first secret value using the first key and the first calculated value; and
verifying the response value based on the predicted first secret value.

8. The authentication method of claim 7, wherein the predicting of the first secret value comprises:
computing binary inner-product of a first shared secret key shared with the claimant entity and the first key; and
performing logical exclusive OR operation of the binary inner-product and the first calculated value.

9. The authentication method of claim 7, wherein the generating of the second calculated value comprises:
choosing the second calculated value randomly;
computing binary inner-product of a second shared secret key shared with the claimant entity and the second key; and
generating the second calculated value by performing logical exclusive OR operation of the binary inner-product and the second secret value.

10. The authentication method of claim 7, wherein the verifying of the response value comprises:
determining whether or not the predicted first secret value matches the second secret value;
generating a first authentication value using the first key, the second key and a first encryption equation, if the predicted first secret value matches the second secret value;
determining authentication to be successful if the first authentication value matches the response value;
generating a second authentication value using the first key, the second key and a second encryption equation, if the predicted first secret value does not match the second secret value; and
determining authentication to be successful if the second authentication value matches the response value.

11. The authentication method of claim 7, wherein the steps of the receiving of the first key and the first calculated value, the generating of the second calculated value, the sending of the second key and the second calculated value, the receiving of the response value, the predicting of the first secret value, and the verifying of the response value, are repeated a plurality of times, and authentication of the verifying entity is determined to be successful if authentication of all the repeated steps succeeds.

12. The authentication method of claim 7, further comprising generating a session secret value by performing logical exclusive OR operation of the predicted first secret value and the second secret value.

13. An authenticating system, comprising a verifying entity and a claimant entity,
wherein the claimant entity sends a first calculated value to the verifying entity, the verifying entity sends a second calculated value to the claimant entity, the claimant entity sends a response value to the verifying entity in response, and the verifying entity authenticates the response value using the first calculated value.

14. The authentication system of claim 13, wherein the claimant entity and the verifying entity share a first and second shared secret keys,
the claimant entity generates the first calculated value using a first key, a first secret value, and the first shared secret key, and sends the first key along with the first calculated value to the verifying entity, and
the verifying entity generates the second calculated value using a second key, a second secret value, and the second shared secret key, and sends the second key along with the second calculated value to the claimant entity.

15. The authentication system of claim 13, wherein the claimant entity
predicts the second secret value using the second calculated value, the second key and the second shared secret key,
chooses one of a first encryption equation and a second encryption equation, depending on whether or not the predicted second secret value matches the first secret value, and
generates the response value using the encryption equation chosen from among the first and second encryption equations, and the first and second keys.

16. The authentication system of claim 13, wherein the verifying entity
predicts the first secret value using the first calculated value, the first key and the first shared secret key,
chooses one of a first encryption equation and a second encryption equation depending on whether or not the predicted first secret value matches the second secret value,
generates an authentication value using the chosen one from among the first and second encryption equations and the first and second keys, and
determines authentication to be successful if the authentication value matches the response value.
